(19) United States
(12) Patent Application Publication
(10) Pub. No.: US 2026/0011482 A1
(43) Pub. Date: Jan. 8, 2026

(54) TRANSFORMER

(71) Applicant: Murata Manufacturing Co., Ltd., Nagaokakyo-shi (JP)

(72) Inventors: Yuuma NOGUCHI, Nagaokakyo-shi (JP); Kiichiro TAKENAKA, Nagaokakyo-shi (JP); Masatoshi HASE, Nagaokakyo-shi (JP)

(21) Appl. No.: 19/257,553

(22) Filed: Jul. 2, 2025

(30) Foreign Application Priority Data
Jul. 3, 2024 (JP) 2024-107545

(51) Int. Cl. H01F 27/28; H01F 19/04

(52) U.S. Cl. CPC H01F 27/2804; H01F 19/04; H01F 27/2823; H01F 2027/2809

(57) ABSTRACT

A transformer includes a first transmission line disposed on a main surface of a first layer, and having a first end into which an input signal is inputted, and a second end electrically connected to an output terminal, and a second transmission line having a first end electrically connected to the first end of the first transmission line and a second end grounded, the second transmission line being disposed on a main surface of a second layer different from the first layer, the second transmission line being electromagnetically coupled to the first transmission line and in which an electric current that flows in a direction opposite to a direction of an electric current flowing through the first transmission line is induced.

### CROSS REFERENCE TO RELATED APPLICATION

This application claims priority from Japanese Patent Application No. 2024-107545, filed on Jul. 3, 2024. The content of these applications are incorporated herein by reference in its entirety.

### BACKGROUND OF THE DISCLOSURE

### 1. Field of the Disclosure

The present disclosure relates to a transformer.

### 2. Description of the Related Art

In recent years, demand has grown for electronic devices with reduced size and thickness. Such an electronic device includes integrated electronic components. For integration of electronic components, integration of magnetic elements including a transformer and loss reduction play a key role. A transformer that can enhance the coefficient of coupling between a primary coil and a secondary coil for loss reduction has been disclosed.

### BRIEF SUMMARY OF THE DISCLOSURE

In a transformer described in Japanese Unexamined Patent Application Publication No. 2012-134354, a primary winding is formed at a multilayer substrate by connecting a lower coil with a single turn and an upper coil with a single turn through a via hole. The transformer includes a coil with a single turn serving as a secondary winding between the lower coil and the upper coil. The transformer can confine the magnetic flux caused by electromagnetic induction between a primary coil portion and a secondary coil portion with an upper surface and a lower surface, and can thus enhance the coefficient of coupling between the primary coil portion and the secondary coil portion and enhance the conversion efficiency. Thus, the transformer can reduce losses.

However, due to the characteristic impedance of a circuit, the area where the primary coil portion and the secondary coil portion overlap in a top view may need to be reduced. In this case, the wire width of the primary coil portion and the secondary coil portion is notably reduced, and the losses are thus increased.

Accordingly, it is a possible benefit of the present disclosure to provide a transformer capable of further reducing losses than existing transformers.

A transformer according to an aspect of the present disclosure includes a first transmission line disposed on a main surface of a first layer, and having a first end into which an input signal is inputted, and a second end electrically connected to an output terminal; and a second transmission line having a first end electrically connected to the first end of the first transmission line and a second end grounded, the second transmission line being disposed on a main surface of a second layer different from the first layer, the second transmission line being electromagnetically coupled to the first transmission line and in which an electric current that flows in a direction opposite to a direction of an electric current flowing through the first transmission line is induced, wherein either one of the first transmission line and the second transmission line includes a first wire and a second wire connected in parallel with the first wire in a range where the first transmission line and the second transmission line overlap when viewed in a lamination direction in which the first layer and the second layer are laminated.

The present disclosure can provide a transformer capable of further reducing losses than existing transformers.

### BRIEF DESCRIPTION OF THE SEVERAL VIEWS OF THE DRAWINGS

FIG. 1 is a schematic diagram of a structure of a transformer;

FIG. 2 is a schematic perspective view of an example of the structure of a transformer;

FIG. 3 is a schematic diagram of a transformer when viewed in a lamination direction;

Each of FIGS. 4A and 4B is a view of parts of a first transmission line and a second transmission line when viewed in a lamination direction;

Each of FIGS. 5A and 5B is a schematic diagram illustrating a connection relationship between the transformer and a capacitor;

FIG. 6 is a schematic diagram illustrating a connection relationship between the transformer and a power supply Vcc;

FIG. 7 is a diagram of an example of a cross section of a transformer including a six-layer substrate;

FIG. 8 is a schematic perspective view of an example of a structure of a transformer according to a first modification example;

FIG. 9 is a schematic perspective view of a transformer according to a second modification example when viewed in the lamination direction;

FIG. 10 is a diagram illustrating an example of definition of a turn;

FIG. 11 is a graph illustrating a relationship between a route length and a Euclidean distance;

FIG. 12 is a schematic diagram of the transformer when viewed in the lamination direction;

FIG. 13 is a structure diagram of an example where the transformer according to the second modification example includes a bridge portion;

FIG. 14 is a diagram of an example of a cross section of a transformer according to a third modification example; and

FIG. 15 is a schematic diagram of a structure of a transformer according to a fourth modification example.

### DETAILED DESCRIPTION OF THE DISCLOSURE

Embodiments of the present disclosure are described below with reference to the drawings.

### Structure

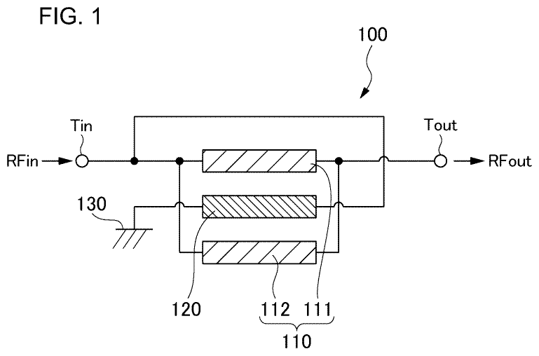

With reference to FIG. 1, a structure of a transformer 100 is roughly described. FIG. 1 is a schematic diagram of a structure of the transformer 100.

The transformer 100 is, for example, a circuit used for impedance matching through impedance conversion using two electromagnetically coupled transmission lines. The transformer 100 also converts between a differential signal and a single-ended signal. The transformer 100 is formed from, for example, a multilayer substrate. Hereafter, for convenience, the terms “primary” and “secondary” are used in describing the transformer 100, but the structure of the transformer 100 may alternatively be configured with the “primary” and “secondary” components interchanged.

As illustrated in FIG. 1, the transformer 100 includes a first transmission line 110 and a second transmission line 120. Each of the transmission lines in the transformer 100 is disposed on main surfaces of multiple layers. Hereafter, for convenience, a direction in which multiple layers are laminated is referred to as “a lamination direction”, and a view in the lamination direction is referred to as “viewed in the lamination direction”.

In the transformer 100, when each of the first transmission line 110 and the second transmission line 120 is to be electromagnetically coupled between different layers, the area in which the first transmission line 110 and the second transmission line 120 overlap when viewed in the lamination direction is determined based on the characteristic impedance of a circuit. Thus, in the transformer 100, the wire width of each transmission line needs to be reduced. In contrast, the transformer 100 has a structure that allows the first transmission line 110 and the second transmission line 120 to have an increased wire width.

The transformer 100 with this structure can prevent breakage of transmission lines that would otherwise result from increased transmission losses and insufficient power tolerance to the power supply and fundamental waves, due to the narrow wire width of the transmission lines.

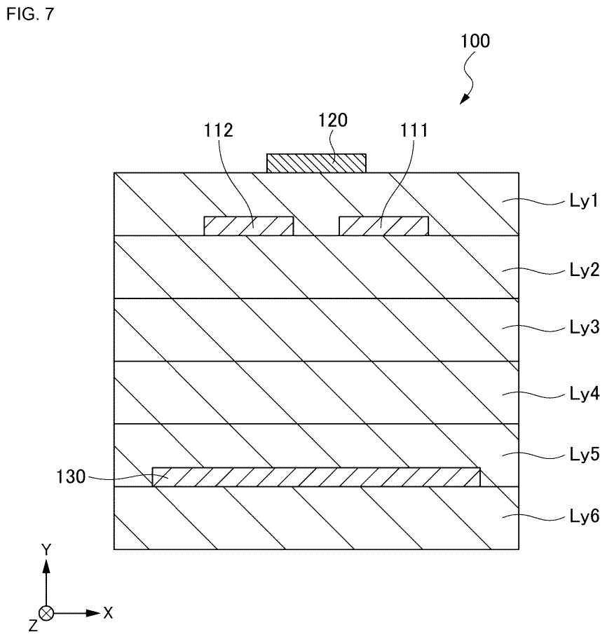

For example, the first transmission line 110 is disposed on a main surface of a first layer (for example, a layer Ly2 in FIG. 7), a first end of the first transmission line 110 is electrically connected to an input terminal Tin and receives an input signal RFin, and a second end of the first transmission line 110 is electrically connected to an output terminal Tout.

The first transmission line 110 includes, for example, a first wire 111 and a second wire 112 connected in parallel with the first wire 111. The first wire 111 is disposed in parallel with the second wire 112 at a predetermined distance. More specifically, in the first transmission line 110, for example, the first wire 111 and the second wire 112 are disposed in parallel with each other at a predetermined distance from each other.

The second transmission line 120 is disposed on, for example, a main surface of a second layer (for example, a layer Ly1 in FIG. 7) different from the layer on which the first transmission line 110 is disposed, and electromagnetically coupled with the first transmission line 110. For example, the first end of the second transmission line 120 is electrically connected to the first end of the first transmission line 110, and the second end of the second transmission line 120 is electrically connected to a ground 130. More specifically, the second transmission line 120 induces an electric current that flows in a direction opposite to the direction of the electric current flowing through the first transmission line 110.

In the transformer 100, the second transmission line 120 is routed to overlap parts of the first wire 111 and the second wire 112 in the first transmission line 110 and a gap between the first wire 111 and the second wire 112 when viewed in the lamination direction. Thus, the transformer 100 has the transmission lines with an increased wire width, and can improve electric power handling capability and reduce losses.

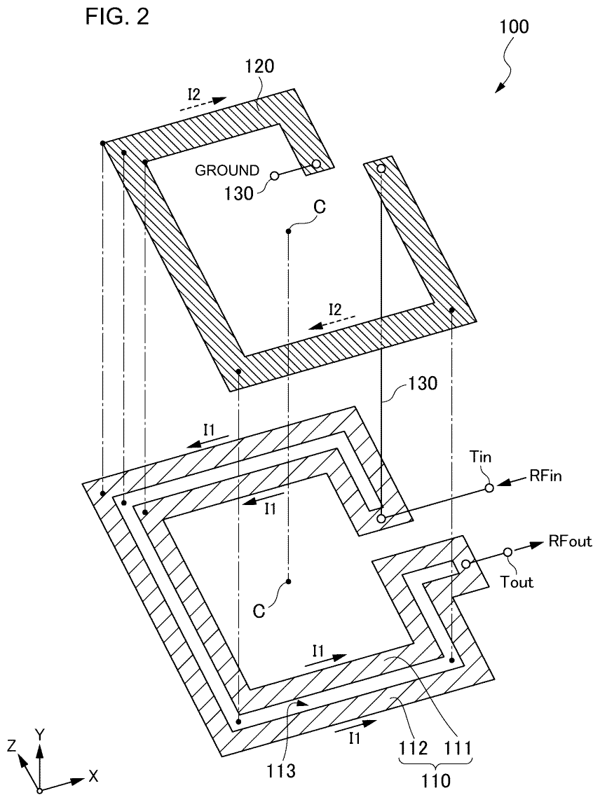

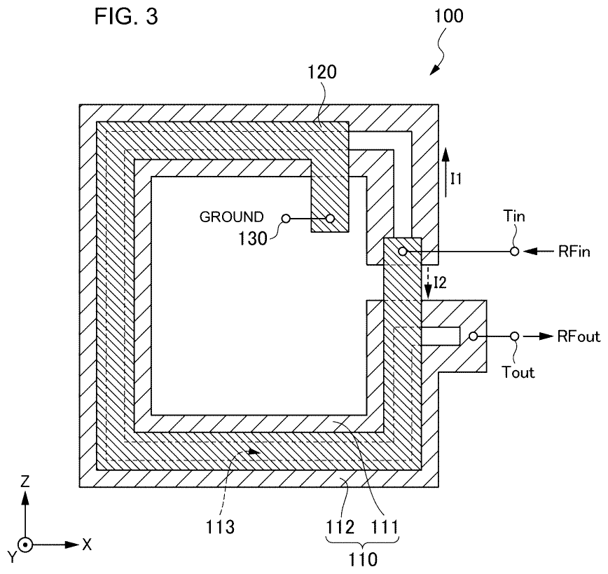

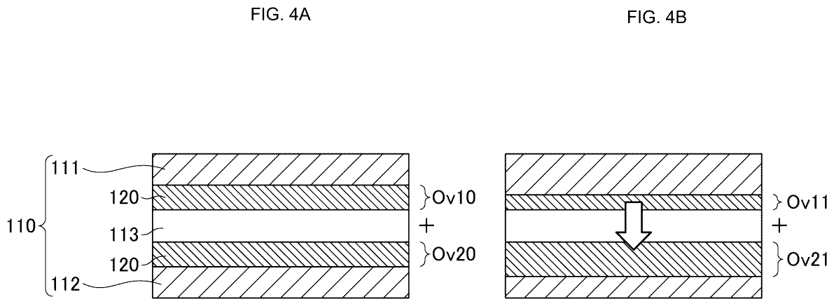

With reference to FIG. 2 and FIG. 3, the structure of the transformer 100 is described below in detail. FIG. 2 is a schematic perspective view of an example of the structure of the transformer 100. FIG. 3 is a schematic diagram of the transformer 100 when viewed in the lamination direction.

In FIG. 2 and FIG. 3, a Y direction corresponds to the lamination direction of the transformer 100, and a X direction and a Z direction are orthogonal to the Y direction. In this case, “a view in the lamination direction” refers to a view in the Y direction in which layers in the multilayer substrate are laminated.

As illustrated in FIG. 2, the transformer 100 is desirably wound along an XZ plane. Thus, the transformer 100 can achieve size reduction. The transformer 100 is desirably designed to coaxially align centers C of the first transmission line 110 and the second transmission line 120. A via conductor electrically connects, for example, the first transmission line 110 and the second transmission line 120 to each other.

In the transformer 100, for example, the first transmission line 110 serves as a primary winding, and the second transmission line 120 serves as a secondary winding. An electric current I1 flows in a direction of arrows drawn by the solid lines through the first transmission line 110 serving as a primary winding. An electric current I2 induced by the electric current I1 flowing through the first transmission line 110 flows in a direction of the arrows drawn by the broken lines through the second transmission line 120.

As illustrated in FIG. 3, the first transmission line 110 includes the first wire 111 and the second wire 112 connected in parallel with each other. The first wire 111 is disposed in parallel with the second wire 112 with a gap 113 interposed therebetween.

The second transmission line 120 is disposed on a main surface of a predetermined layer not to cross the first transmission line 110 when viewed in the lamination direction. The second transmission line 120 is disposed along the gap 113 between the first wire 111 and the second wire 112 to overlap parts of the first wire 111 and the second wire 112 when viewed in the lamination direction. Thus, the transformer 100 has the second transmission line 120 with an increased wire width by the gap 113, and can thus reduce losses.

With reference to FIGS. 4A and 4B, unlike an existing transformer, the transformer 100 that retains the area in which the first transmission line 110 and the second transmission line 120 overlap when viewed in the lamination direction, and that has the first transmission line 110 and the second transmission line 120 with an increased wire width is described. Each of FIGS. 4A and 4B is a diagram of parts of the first transmission line 110 and the second transmission line 120 when viewed in the lamination direction.

In the transformer 100, the area where two transmission lines overlap when viewed in the lamination direction is determined based on, for example, characteristic impedance of a circuit. In this case, the transformer needs to have two transmission lines with a notably narrow wire width. When the transmission lines have a narrow wire width, signal losses increase, power tolerance decreases, and the area in which the two transmission lines overlap is reduced by the displacement of either one of the two transmission lines due to the displacement of layers in a laminated structure. Thus, problems such as a failure in obtaining intended characteristics occur.

For example, when the transformer 100 has a structure where two wires connected in parallel with each other and disposed on different layers do not have a gap when viewed in the lamination direction, more specifically, when the transformer 100 has a structure where only one of the transmission lines has an increased wire width, signal losses can be reduced to some extent, and a problem of degradation of characteristics due to the displacement of layers may be solved. However, the wire width of the other transmission line remains narrow. This structure thus fails to completely solve the problem of an increase of signal losses, and fails to solve the problem of degradation of power tolerance.

Thus, the transformer 100 has a structure in which the two transmission lines have an increased wire width while the desired area where the two electromagnetically coupled transmission lines overlap is ensured. As illustrated in FIG. 4A, the desired area where the two transmission lines overlap is a sum of an area of an overlap Ov10 and an area of an overlap Ov20. As illustrated in FIG. 4A, the first transmission line 110 has a wire width larger than the sum of the overlap Ov10 and the overlap Ov20. As illustrated in FIG. 4A, the second transmission line 120 has a wire width larger than the sum of the overlap Ov10 and the overlap Ov20 by the width of the gap 113. Thus, the transformer 100 has the two transmission lines with an increased wire width, using the gap 113 in which the capacitive coupling of the two transmission lines is weakened. In contrast, an existing transformer is formed from two transmission lines with a wire width that is the sum of the wire width of the overlap Ov10 and the wire width of the overlap Ov20.

In the transformer 100, when, for example, at least one of the first transmission line 110 and the second transmission line 120 is displaced in the XZ plane, the area where the first transmission line 110 and the second transmission line 120 overlap is retained. This is obvious because, in the transformer 100, the sum of the area of the overlap Ov10 and the area of the overlap Ov20 in FIG. 4A is equal to the sum of the area of an overlap Ov11 and the area of an overlap Ov21 in FIG. 4B. Thus, the transformer 100 can retain desired characteristics when, for example, the two transmission lines are displaced from each other due to displacement of layers in the laminated structure during a manufacturing process.

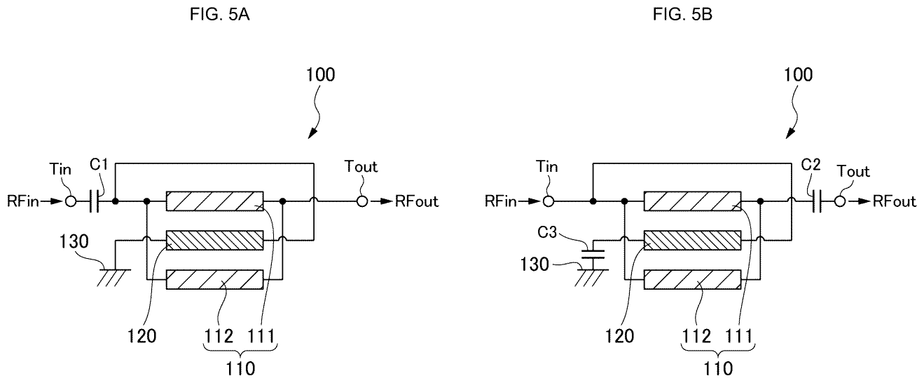

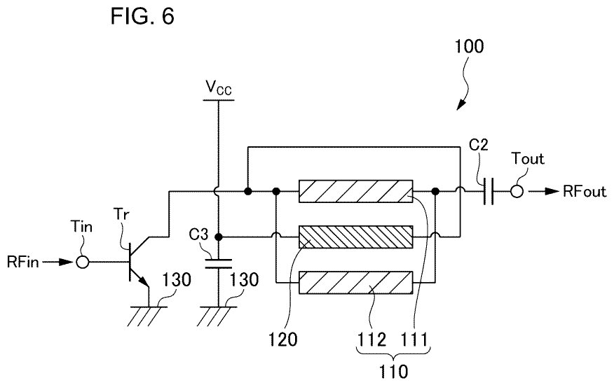

With reference to FIG. 5A, FIG. 5B and FIG. 6, the connection relationship between the transformer 100 and various elements is now described. Each of FIGS. 5A and 5B is a schematic diagram illustrating the connection relationship between the transformer 100 and a capacitor. FIG. 6 is a schematic diagram illustrating the connection relationship between the transformer 100 and the power supply Vcc.

As illustrated in FIG. 5A, in the transformer 100, for example, an input signal RFin may be inputted into the input terminal Tin through a capacitor C1. The transformer 100 with this structure can prevent direct current flow between the input terminal Tin that receives the power supply Vcc and the ground 130. In addition, the transformer 100 can prevent direct current flow between the input terminal Tin that receives the power supply Vcc and the output terminal Tout.

As illustrated in FIG. 5B, the transformer 100 may include a capacitor between, for example, the output terminal Tout and the ground 130. More specifically, in the transformer 100, a capacitor C2 is serially disposed between the first transmission line 110 and the output terminal Tout, and a capacitor C3 is serially disposed between the second transmission line 120 and the ground 130. Thus, the transformer 100 can prevent direct current flow between the input terminal Tin that receives the power supply Vcc and each of the output terminal Tout and the ground 130.

As illustrated in FIG. 6, the transformer 100 may supply, for example, the power supply Vcc from a port of the ground 130 to which direct current flow is prevented by the capacitor. More specifically, in the transformer 100, the power supply Vcc is electrically connected to the port of the ground 130 in the structure illustrated in FIG. 5B. Thus, in the transformer 100, the circuit that is to have a structure where the power supply Vcc is connected to a collector of a transistor Tr with an inductor interposed therebetween can reduce its size by eliminating the inductor.

### Manufacturing Method

With reference to FIG. 7, an example of a method for manufacturing the transformer 100 is described. FIG. 7 is a diagram of an example of a cross section of the transformer 100 including a six-layer substrate. FIG. 7 simply illustrates components relating to the transformer 100 without illustrating, for example, a via conductor, wires, and electronic elements other than the relating components.

First, for example, on a semiconductor substrate, a layer Ly6 is formed by, for example, chemical vapor deposition, sputtering, or spin coating. The layer Ly6 is formed from, for example, si02, SiN, or SiON, and disposed to protect, for example, various electronic elements. For example, each of layers Ly5, Ly4, Ly3, Ly2, and Ly1, described later, is the same as the layer Ly6. The ground 130 is then formed on the layer Ly6 by, for example, an etching process. The layers Ly5, Ly4, Ly3, and Ly2 are then formed in the same manner as the layer Ly6. The first wire 111 and the second wire 112 are then formed on the layer Ly2 by, for example, an etching process while being spaced apart from each other with the gap 113. Thereafter, a via hole is formed in the layer Ly1 with a technique of forming a hole using, for example, laser. The via hole is then filled with a conductor to form a via conductor (not illustrated). The second transmission line 120 is then formed on the layer Ly1 to be electrically connected to the first transmission line 110 through the via conductor. Thus, the transformer 100 is manufactured.

As described above, when the ground 130 is disposed at the lowest layer, more specifically, when an insulator film is disposed between the ground 130 and the layer Ly2, the distance between the ground 130 and each of the first transmission line 110 and the second transmission line 120 can be maintained, and thus, the parasitic capacitance between the ground 130 and each of the first transmission line 110 and the second transmission line 120 can be reduced.

In the above description, the first transmission line 110 is disposed at the uppermost layer, but this is not the only possible example, and the first transmission line 110 may be disposed at an intermediate layer (for example, the layer Ly2 or Ly3). In the above description, the transformer 100 includes the ground 130 disposed at the lowest layer, but this is not the only possible example. For example, the ground 130 may be disposed at, for example, the layer Ly5 or Ly4.

### MODIFICATION EXAMPLES

### First Modification Example

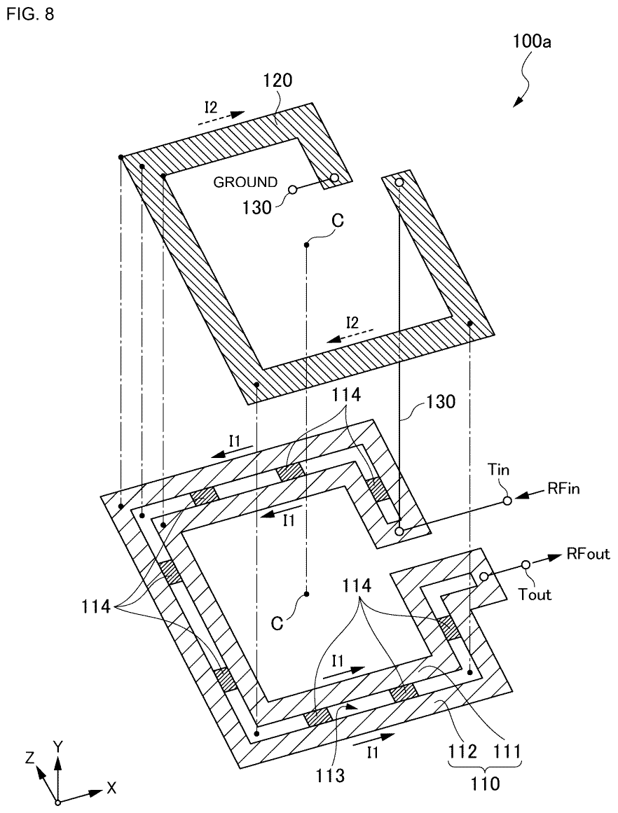

With reference to FIG. 8, a transformer 100a according to a first modification example is described. FIG. 8 is a schematic perspective view of an example of the structure of the transformer 100a according to the first modification example. Hereafter, the transformer 100a is described in terms of points different from those of the transformer 100, and points not particularly described are the same as those of the transformer 100.

As illustrated in FIG. 8, the transformer 100a includes bridge portions 114, unlike the transformer 100. The bridge portions 114 are disposed in the gap 113, and electrically connects the first wire 111 and the second wire 112. In other words, in the transformer 100a, the bridge portions 114 define slits in the gap 113 between the first wire 111 and the second wire 112. This structure further facilitates forming the first transmission line 110 in the etching process during the manufacturing process, than a structure simply including the gap 113 formed between the first wire 111 and the second wire 112. More specifically, this structure can reduce the tolerance caused in the gap 113 between the first wire 111 and the second wire 112 during the manufacturing process.

### Second Modification Example

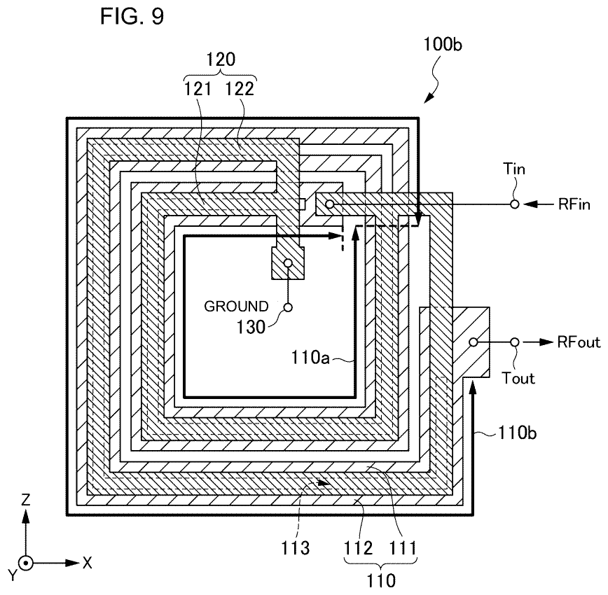

With reference to FIG. 9, a transformer 100b according to a second modification example is described. FIG. 9 is a schematic diagram of the transformer 100b according to the second modification example when viewed in the lamination direction. Hereafter, the transformer 100b is described in terms of points different from those of the transformer 100, and points not particularly described are the same as those of the transformer 100.

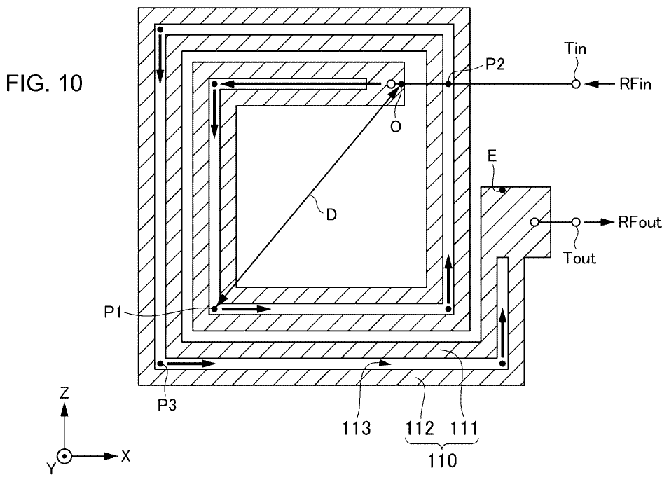

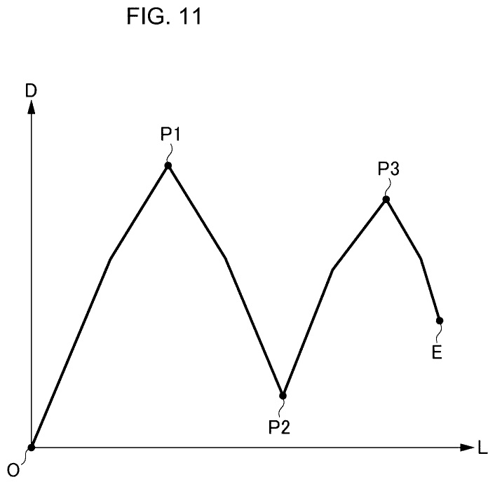

As illustrated in FIG. 9, unlike the transformer 100, the transformer 100b according to the second modification example includes a coil portion in which the first transmission line 110 is wound into multiple turns in the XZ plane on the main surface of a predetermined layer. With reference to FIG. 10 and FIG. 11, an example of definition of “a turn” in the first transmission line 110 is described. FIG. 10 is a diagram illustrating an example of definition of a turn. FIG. 11 is a graph illustrating a relationship between a route length and a Euclidean distance.

FIG. 10 defines an XY orthogonal coordinate system having an end portion of the inner periphery of the first transmission line 110 serving as an origin O. The first transmission line 110 extends from the origin O to an end E of the outer periphery through any route. In FIG. 10, a route length from the origin O to any point P of the first transmission line 110 is indicated by L. In FIG. 10, a Euclidean distance between the origin O and the point P is indicated by D.

In this case, as illustrated in FIG. 11, at a point P1 of the first transmission line 110, the Euclidean distance D indicates a first maximum value. At a point P2, the Euclidean distance D indicates a minimum value, and at a point P3, the Euclidean distance D indicates a second maximum value, and then reaches the end E. In the transformer 100b according to the second modification example, as an example, the number of pairs each including a maximum value and a minimum value appearing after the maximum value may be defined as the number of turns. Alternatively, the number of maximum values may be defined as the number of turns. More specifically, in this case, the first transmission line 110 illustrated in FIG. 10 includes one pair of the first maximum value and the minimum value, and a second maximum value, and thus is formed from two turns.

Alternatively, the number obtained by dividing, by 360 degrees, the total angle by which the first transmission line 110 has changed its direction and rounding the resultant off may be defined as the number of turns. More specifically, in FIG. 10, the first transmission line 110 changes its direction at the respective corners by 90 degrees. Thus, the first transmission line 110 according to the second modification example changes its direction by 630 degrees, and thus may be regarded as being formed from two turns.

Hereafter, for convenience, of the coil portions in the first transmission line 110, the wire in the first turn from the inside is referred to as “a first coil portion 110a”, and the wire in the second turn from the inside and longer than the first coil portion 110a is referred to as “a second coil portion 110b”.

With reference back to FIG. 9, the structure of the transformer 100b according to the second modification example is described. As illustrated in FIG. 9, the first transmission line 110 in the transformer 100b includes the first wire 111 and the second wire 112 arranged in the XZ plane in parallel with the first wire 111 with the gap 113 interposed therebetween.

The first wire 111 and the second wire 112 are arranged in the XZ plane in parallel and each include the first coil portion 110a as a first turn from the inner side, and a second coil portion 110b as a second turn from the inner side, arranged in parallel with the first coil portion 110a, and through which an electric current flows in the same direction as the electric current flowing through the first coil portion 110a.

As illustrated in FIG. 9, the second transmission line 120 in the transformer 100b includes a third wire 121 and a fourth wire 122. For example, the third wire 121 extends along the gap 113 between the first wire 111 and the second wire 112 in the first coil portion 110a to overlap parts of the first wire 111 and the second wire 112 when viewed in the lamination direction. For example, the fourth wire 122 is connected in parallel with the third wire 121, and extends along the gap 113 between the first wire 111 and the second wire 112 in the second coil portion 110b to overlap parts of the first wire 111 and the second wire 112 when viewed in the lamination direction. Thus, in the transformer 100b, the transmission line has an increased wire width.

In the above description, the first transmission line 110 is formed from two turns, but this is not the only possible example. For example, the first transmission line 110 is routed to maintain a long distance between the input terminal Tin or an end portion (hereafter simply referred to as “an input terminal Tin”) of the first transmission line 110 electrically connected to the input terminal Tin and the output terminal Tout or an end portion (hereafter simply referred to as “an output terminal Tout”) of the first transmission line 110 electrically connected to the output terminal Tout.

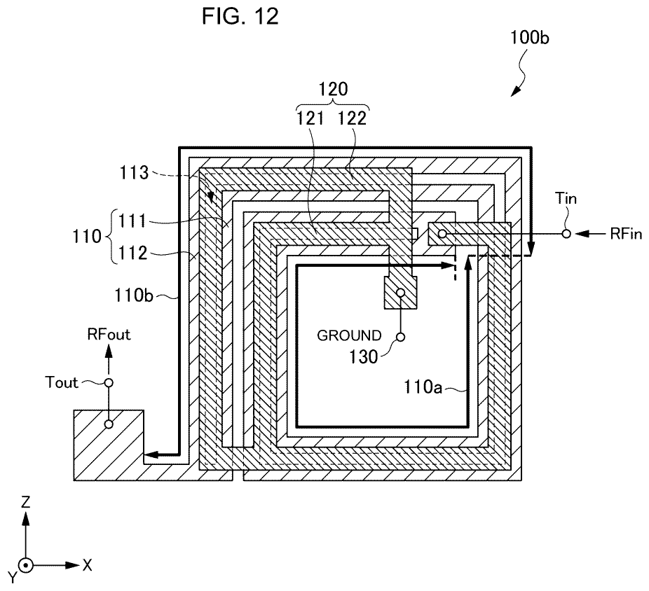

With reference to FIG. 12, the first transmission line 110 routed to maintain a long distance between the input terminal Tin and the output terminal Tout is described. FIG. 12 is a schematic diagram of the transformer 100b when viewed in the lamination direction. Hereafter, the transformer 100b in FIG. 12 is described in terms of points different from those of the transformer 100b in FIG. 9, and points not particularly described are the same as those of the transformer 100b in FIG. 9.

The first transmission line 110 in the transformer 100b in FIG. 12 is disposed to turn to the point P3 in FIG. 10. More specifically, the first transmission line 110 is wound into one and a half turns in the XZ plane. In this case, the distance between the output terminal Tout and each of the input terminal Tin and the ground 130 is the largest. This structure facilitates manufacture of the transformer 100b.

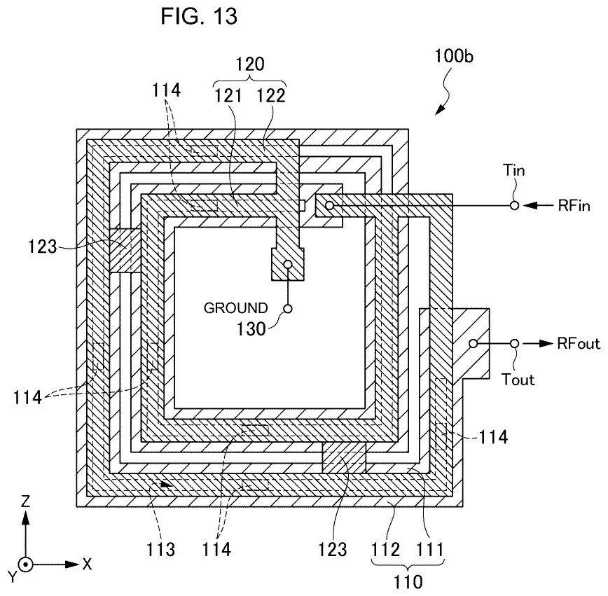

With reference to FIG. 13, a structure of the transformer 100b including bridge portions is described. FIG. 13 is a diagram of an example of the transformer 100b according to a second modification example including the bridge portions.

As illustrated in FIG. 13, the transformer 100b may include bridge portions in, for example, at least one of the two transmission lines. More specifically, the transformer 100b may include bridge portions 114 in the first transmission line 110, or bridge portions 123 in the second transmission line 120.

In this case, the first wire 111 is electrically connected to the second wire 112 through at least one of the bridge portions 114 in the gap 113 between the first end and the second end. In addition, the third wire 121 is electrically connected to the fourth wire 122 through at least one of the bridge portions 123 in the gap between the third wire 121 and the fourth wire 122 between the first end and the second end.

This structure thus facilitates forming of the first transmission line 110 and the second transmission line 120 in the etching process of the manufacturing process. More specifically, this structure can reduce the tolerance caused in the manufacturing process in the gaps of the first transmission line 110 and the second transmission line 120.

### Third Modification Example

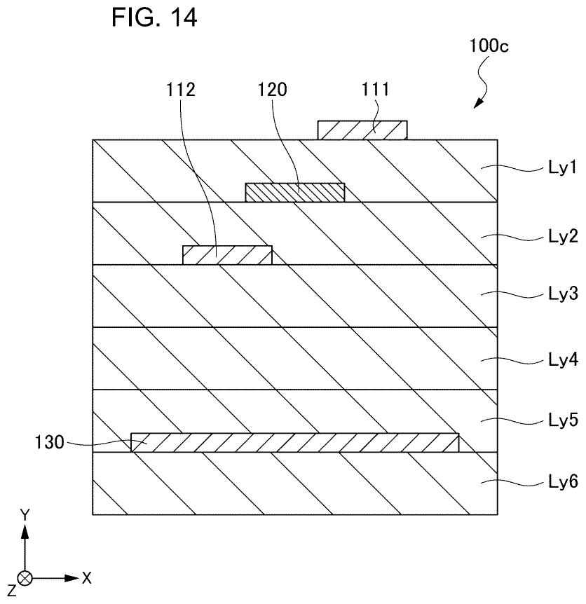

With reference to FIG. 14, a transformer 100c according to a third modification example is described. FIG. 14 is a diagram of an example of a cross section of the transformer 100c according to the third modification example. FIG. 14 simply illustrates components relating to the transformer 100c without illustrating, for example, a via conductor, wires, and electronic elements other than the relating components. Hereafter, the transformer 100c is described in terms of points different from those of the transformer 100, and points not particularly described are the same as those of the transformer 100.

As illustrated in FIG. 14, unlike in the transformer 100 illustrated in FIG. 7, in the transformer 100c according to the third modification example, the first wire 111 is disposed on the main surface of the layer Ly1 different from the main surface of the layer Ly3 on which the second wire 112 is disposed. More specifically, the transformer 100c includes the first wire 111 disposed on the main surface of the layer Ly1, the second wire 112 disposed on the main surface of the layer Ly3, and the second transmission line 120 disposed on the main surface of the layer Ly2 between the layer Ly1 and the layer Ly3.

When viewed in the lamination direction, the second transmission line 120 is disposed to allow a portion of the main surface facing in the +Y direction to overlap a part of the first wire 111 and to allow a portion of the main surface facing in the −Y direction to overlap a part of the second wire 112. Thus, the second transmission line 120 can be appropriately designed in accordance with the conditions under which wires are installable.

In FIG. 14, the second transmission line 120, the first wire 111, and the second wire 112 are disposed on adjacent layers, but the structure is not limited to this example. For example, each of the wires may be disposed while being spaced apart from the other with predetermined layers interposed therebetween.

### Fourth Modification Example

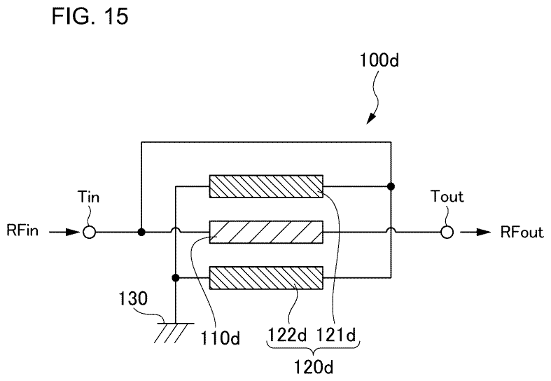

With reference to FIG. 15, a transformer 100d according to a fourth modification example is described. FIG. 15 is a schematic diagram of a structure of the transformer 100d according to a fourth modification example. Hereafter, the transformer 100d is described in terms of points different from those of the transformer 100, and points not particularly described are the same as those of the transformer 100.

As illustrated in FIG. 15, unlike the transformer 100 illustrated in FIG. 1, the transformer 100d according to the fourth modification example includes a second transmission line 120d including two wires connected in parallel.

More specifically, the second transmission line 120d includes a first wire 121d and a second wire 122d disposed in parallel with the first wire 121d with a gap interposed therebetween when viewed in the lamination direction. In contrast, a first transmission line 110d is disposed on the main surface of a layer different from the layer on which the second transmission line 120d is disposed to overlap parts of the first wire 121d and the second wire 122d and the gap when viewed in the lamination direction.

More specifically, the transformer 100d has a structure in which the terminal electrically connected to the ground 130 and the output terminal Tout are interchanged relative to the transformer 100 illustrated in FIG. 2. Thus, the transformer 100d has the first transmission line 110d and the second transmission line 120d with an increased wire width, and can thus reduce losses.

### Summarization

<1> A transformer 100 according to an exemplary embodiment of the present disclosure includes a first transmission line 110 disposed on a main surface of a first layer, and having a first end into which an input signal RFin is inputted, and a second end electrically connected to an output terminal Tout, and a second transmission line 120 having a first end electrically connected to the first end of the first transmission line 110 and a second end grounded, and disposed on a main surface of a second layer different from the first layer, the second transmission line 120 being electromagnetically coupled to the first transmission line 110 and in which an electric current that flows in a direction opposite to a direction of an electric current flowing through the first transmission line 110 is induced, wherein either one of the first transmission line 110 and the second transmission line 120 includes a first wire 111 and a second wire 112 connected in parallel with the first wire 111 in a range where the first transmission line 110 and the second transmission line 120 overlap when viewed in a lamination direction in which the first layer and the second layer are laminated. Thus, the transformer 100 has the transmission lines with an increased wire width. The transformer 100 can thus reduce degradation of characteristics due to the displacement of layers in the laminated structure, and reduce losses.

<2> In a transformer 100 according to an exemplary embodiment of the present disclosure dependent on the transformer described in <1>, wherein the first transmission line 110 includes the first wire 111 and the second wire 112 disposed in parallel with the first wire 111 with a gap 113 interposed therebetween when viewed in the lamination direction, and wherein the second transmission line 120 is disposed on the main surface of the second layer to overlap a part of the first wire 111, a part of the second wire 112, and the gap 113 when viewed in the lamination direction. Thus, the transformer 100 has the transmission lines with an increased wire width. The transformer 100 can thus reduce degradation of characteristics due to the displacement of layers in the laminated structure, improve the electric power handling capability, and reduce losses.

<3> In a transformer 100d according to an exemplary embodiment of the present disclosure dependent on the transformer described in <1>, wherein the second transmission line 120d includes a first wire 121d and a second wire 122d disposed in parallel with the first wire 121d with a gap interposed therebetween when viewed in the lamination direction, and wherein the first transmission line 110d is disposed on the main surface of the first layer to overlap a part of the first wire 121d, a part of the second wire 122d, and the gap when viewed in the lamination direction. Thus, the transformer 100 has the transmission lines with an increased wire width. The transformer 100 can thus reduce degradation of characteristics due to the displacement of layers in the laminated structure, improve the electric power handling capability, and reduce losses.

<4> In a transformer 100a according to an exemplary embodiment of the present disclosure dependent on the transformer described in any one of <1> to <3>, wherein the first wire 111 is electrically connected to the second wire 112 with at least one bridge portion 114 between a first end and a second end. Thus, the transformer 100 can be easily manufactured, and has the transmission lines with an increased wire width. The transformer 100 can thus reduce degradation of characteristics due to the displacement of layers, improve the electric power handling capability, and reduce losses.

<5> In a transformer 100b according to an exemplary embodiment of the present disclosure dependent on the transformer described in any one of <1> to <4>, the first wire 111 and the second wire 112 are disposed in parallel with each other when viewed in the lamination direction, and each include a coil portion wound on a main surface of one layer, and the coil portion includes a first coil portion 110a having one turn and a second coil portion 110b disposed in parallel with the first coil portion 110a when viewed in the lamination direction, the second coil portion 110b being longer than the first coil portion 110a and through which an electric current flows in a direction the same as a direction of an electric current flowing through the first coil portion 110a. Thus, the transformer 100 has the transmission lines with an increased wire width. The transformer 100 can thus reduce degradation of characteristics due to the displacement of layers in the laminated structure, improve the electric power handling capability, and reduce losses.

<6> In a transformer 100b according to an exemplary embodiment of the present disclosure dependent on the transformer described in <5>, wherein either one of the first transmission line 110 and the second transmission line 120 that includes neither the first wire 111 nor the second wire 112 includes a third wire 121 that is disposed to overlap, when viewed in the lamination direction, a part of the first wire 111, a part of the second wire 112, and the gap 113 between the first wire 111 and the second wire 112 in the first coil portion 110a, and a fourth wire 122 that is disposed to overlap, when viewed in the lamination direction, a part of the first wire 111, a part of the second wire 112, and the gap 113 between the first wire 111 and the second wire 112 in the second coil portion 110b. Thus, the transformer 100 has the transmission lines with an increased wire width. The transformer 100 can thus reduce degradation of characteristics due to the displacement of layers in the laminated structure, improve the electric power handling capability, and reduce losses.

<7> In a transformer 100c according to an exemplary embodiment of the present disclosure dependent on the transformer described in any one of <1> to <6>, wherein the first wire 111 is disposed on the main surface of a layer (for example, the layer Ly1 in FIG. 14) different from a layer (for example, the layer Ly3 in FIG. 14) on which the second wire 112 is disposed, and either one of the first transmission line 110 and the second transmission line 120 that includes neither the first wire 111 nor the second wire 112 (for example, the second transmission line 120 in FIG. 14) is disposed on the main surface of a layer (for example, the layer Ly2 in FIG. 14) between the layer on which the first wire 111 is disposed and the layer on which the second wire 112 is disposed. Thus, the transformer 100 has the transmission lines with an increased wire width. The transformer 100 can thus reduce degradation of characteristics due to the displacement of layers in the laminated structure, improve the electric power handling capability, and reduce losses.

The embodiments described above are provided to facilitate understanding of the present disclosure and are not intended to limit the scope of the present disclosure. The present disclosure may be modified or improved without departing from its spirit, and includes equivalents thereof. In other words, design modifications made as appropriate by those skilled in the art to the described embodiments are also included within the scope of the present disclosure, as long as the features of the disclosure are retained. The components and arrangements of the components in the embodiments are not limited to the illustrated examples and may be modified as appropriate.

What is claimed is:

1. A transformer, comprising:
a first transmission line on a main surface of a first layer, and having a first end into which an input signal is input, and a second end electrically connected to an output terminal; and
a second transmission line having a first end electrically connected to the first end of the first transmission line and a second end that is grounded, the second transmission line being on a main surface of a second layer, and being electromagnetically coupled to the first transmission line,
wherein the second layer is different from the first layer, and is laminated to the first layer in a lamination direction,
wherein an electric current flowing through the second transmission line is induced by and flows in a direction opposite to an electric current flowing through the first transmission line,
wherein either one of the first transmission line and the second transmission line comprises a first wire and a second wire connected in parallel with the first wire at a location where the first transmission line and the second transmission line overlap each other when viewed in the lamination direction of the first layer and the second layer.

2. The transformer according to claim 1,
wherein the first transmission line comprises the first wire and the second wire,
wherein the second transmission line is on the main surface of the second layer and overlaps a part of the first wire, a part of the second wire, and a gap between the first wire and the second wire when viewed in the lamination direction.

3. The transformer according to claim 1,
wherein the second transmission line comprises the first wire and the second wire, and
wherein the first transmission line is on the main surface of the first layer and overlaps a part of the first wire, a part of the second wire, and a gap between the first wire and the second wire when viewed in the lamination direction.

4. The transformer according to claim 1, wherein the first wire is electrically connected to the second wire with at least one bridge.

5. The transformer according to claim 1,
wherein the first wire and the second wire are in parallel with each other when viewed in the lamination direction, and each comprise a coil portion, and
wherein the coil portion comprises
a first coil portion having one turn, and
a second coil portion in parallel with the first coil portion when viewed in the lamination direction, the second coil portion being longer than the first coil portion and having an electric current flowing therethrough in a direction that is the same as a direction of an electric current flowing through the first coil portion.

6. The transformer according to claim 2,
wherein the first wire and the second wire are in parallel with each other when viewed in the lamination direction, and each comprise a coil portion, and
wherein the coil portion comprises
a first coil portion having one turn, and
a second coil portion in parallel with the first coil portion when viewed in the lamination direction, the second coil portion being longer than the first coil portion and having an electric current flowing therethrough in a direction that is the same as a direction of an electric current flowing through the first coil portion.

7. The transformer according to claim 3,
wherein the first wire and the second wire are in parallel with each other when viewed in the lamination direction, and each comprise a coil portion, and
wherein the coil portion comprises
a first coil portion having one turn, and
a second coil portion in parallel with the first coil portion when viewed in the lamination direction, the second coil portion being longer than the first coil portion and having an electric current flowing therethrough in a direction that is the same as a direction of an electric current flowing through the first coil portion.

8. The transformer according to claim 4,
wherein the first wire and the second wire are in parallel with each other when viewed in the lamination direction, and each comprise a coil portion, and
wherein the coil portion comprises
a first coil portion having one turn, and
a second coil portion in parallel with the first coil portion when viewed in the lamination direction, the second coil portion being longer than the first coil portion and having an electric current flowing therethrough in a direction that is the same as a direction of an electric current flowing through the first coil portion.

9. The transformer according to claim 5,
wherein whichever of the first transmission line or the second transmission line that does not comprise the first wire and the second wire, comprises:
a third wire that overlaps a part of the first wire, a part of the second wire, and a gap between the first wire and the second wire in the first coil portion, when viewed in the lamination direction, and
a fourth wire that overlaps a part of the first wire, a part of the second wire, and a gap between the first wire and the second wire in the second coil portion, when viewed in the lamination direction.

10. The transformer according to claim 1,
wherein the first wire is on a main surface of a layer different from a layer on which the second wire is disposed, and
wherein whichever of the first transmission line or the second transmission line that does not comprise the first wire or the second wire is on a main surface of a layer between the layer on which the first wire is disposed and the layer on which the second wire is disposed.
